(19) United States
(12) Patent Application Publication
(10) Pub. No.: US 2022/0404825 A1
(43) Pub. Date: Dec. 22, 2022

(54) METHOD FOR REMOTELY CONTROLLING A ROBOT

(71) Applicant: Robert Bosch GmbH, Stuttgart (DE)

(72) Inventors: Stefan Nordbruch, Leonberg (DE); Carolin Noack, Bad Segeberg (DE); Rolf Nicodemus, Bietigheim-Bissingen (DE); Sven Schenkelberger, Tamm (DE)

(21) Appl. No.: 17/638,301

(22) PCT Filed: Jul. 27, 2020
(86) PCT No.: PCT/EP2020/071088

§ 371 Date: Feb. 25, 2022

(30) Foreign Application Priority Data
Sep. 23, 2019 (DE) 10 2019 214 418.7

(51) Int. Cl. G05D 1/00; H04W 4/44; H04L 9/00

(52) U.S. Cl. CPC G05D 1/0022; G05D 1/0077; H04W 4/44; H04L 9/50; G05D 2201/0216; H04L 2209/84

(57) ABSTRACT

A method for remotely controlling a robot situated within a factory infrastructure. The method includes: receiving safety condition signals, which represent at least one safety condition which must be met for the robot to be allowed to be remotely controlled; checking whether the at least one safety condition is met; generating remote control signals for remotely controlling the robot based on a result of the check whether the at least one safety condition is met; and outputting the generated remote control signals. A device, a computer program, and a machine-readable memory medium, are also described.

### FIELD

The present invention relates to a method for remotely controlling a robot situated within a factory infrastructure. The present invention furthermore relates to a device, to a computer program, and to a machine-readable memory medium.

### BACKGROUND INFORMATION

European Patent Application No. EP 2 769 809 A1 describes a method for operating a mobile robot.

European Patent Application No. EP 2 894 532 A1 relates to an autonomous robot device, to a base station, and to a method for operating the same.

### SUMMARY

An object of the present invention is to provide efficient remote control of a robot.

This object may be achieved in accordance with the present invention. Advantageous embodiments of the present invention are disclosed herein.

According to a first aspect of the present invention, a method for remotely controlling a robot situated within a factory infrastructure is provided. In accordance with an example embodiment of the present invention, the method includes the following steps:

receiving safety condition signals, which represent at least one safety condition which must be met for the robot to be allowed to be remotely controlled;

checking whether the at least one safety condition is met; generating remote control signals for remotely controlling the robot based on a result of the check whether the at least one safety condition is met; and

outputting the generated remote control signals.

According to a second aspect of the present invention, a device is provided, which is configured to carry out all steps of the method according to the first aspect.

According to a third aspect of the present invention, a computer program is provided, encompassing commands which, during the execution of the computer program by a computer, for example by the device according to the second aspect, prompt the same to carry out a method according to the first aspect.

According to a fourth aspect of the present invention, a machine-readable memory medium is provided, on which the computer program according to the third aspect is stored.

The present invention is based on and includes the finding that the above object may be achieved, in accordance with an example embodiment of the present invention, that it is checked, prior to remotely controlling the robot, whether the at least one safety condition is met. If this should not be the case, in particular, a generation of remote control signals for remotely controlling the robot is dispensed with. The remote control signals are preferably only generated and output when the at least one safety condition is met.

This yields the technical advantage, for example, that the remote control of the robot may be carried out safely.

This thus, in particular, yields the technical advantage that a concept for the efficient remote control of a robot is provided.

In one specific embodiment of the present invention, the remote control signals encompass control signals for controlling a movement of the robot.

This, for example, yields the technical advantage that the robot may be efficiently remotely controlled.

According to one specific embodiment of the present invention, the robot includes multiple arms which, in particular, are connected to one another in an articulated manner.

According to one specific embodiment of the present invention, the robot includes an end effector, for example a gripper.

The robot is a mobile robot, for example. A mobile robot includes a drive motor, for example. The mobile robot includes, for example, one or multiple caster(s) or tire(s) on which it is able to roll in order to move.

The robot is a stationary robot, for example.

The robot includes one or multiple surroundings sensor(s), for example.

A surroundings sensor within the meaning of the description is one of the following surroundings sensors, for example: radar sensor, LIDAR sensor, infrared sensor, video sensor, ultrasonic sensor, and magnetic field sensor.

A robot within the meaning of the description herein denotes, in particular, an automatic handling device, in particular, a universally usable automatic handling device, including, for example, multiple axes whose movements are freely programmable (i.e., in particular, without mechanical or human intervention), for example, with respect to the sequence of motions and, for example, paths or angles and, for example, are possibly sensor-guided.

A robot within the meaning of the description herein is, for example, equippable or equipped with grippers and/or tools and/or, for example, other manufacturing means.

A robot within the meaning of the description herein may, for example, carry out handling and/or manufacturing tasks.

According to one specific embodiment of the present invention, it is provided that the at least one safety condition in each case selects one element from the following groups of safety conditions: presence of a predetermined Safety Integrity Level (SIL, or Automotive Safety Integrity Level (ASIL)) of at least the robot and an infrastructure, in particular, including a communication line and/or communication components, for remotely controlling a robot, in particular, with respect to the overall systems in the robot and infrastructure as well as, in particular parts; e.g., components, algorithms, interfaces, etc.; presence of a maximum latency period of a communication between the robot and a remote control device for remotely controlling the robot based on the remote control signals; presence of a predetermined computer protection level of a device for carrying out the method steps; presence of predetermined components and/or algorithms and/or communication options which are used to carry out the method steps; presence of a redundancy and/or diversity in predetermined components and/or algorithms and/or communication options which are used to carry out the method steps; presence of predetermined availability information which indicates an availability of predetermined components and/or algorithms and/or communication options; presence of predetermined quality criteria of the predetermined components and/or algorithms and/or communication options; presence of a plan which encompasses measures for reducing errors and/or measures in the event of failures of predetermined components and/or algorithms and/or communication options and/or measures for error analyses and/or measures in the event of misinterpretations; presence of one or multiple fallback scenario(s); presence of a predetermined function; presence of a predetermined traffic situation; presence of predetermined weather, a maximum possible time for carrying out and/or executing a method step or multiple method steps; presence of a test result that elements and/or functions which are used to carry out the method are presently functioning error-free.

A communication line is, for example, a communication line between the device according to the second aspect and the robot. A communication link includes, for example, one or multiple communication channel(s).

In one specific embodiment of the present invention, a component which is used to carry out the method according to the first aspect is an element selected from the following group of components: surroundings sensor, robot, factory infrastructure, remote control device, device according to the second aspect, robot system, in particular drive system, clutch system, braking system, communication interface of the robot and/or of the factory infrastructure, processor, input, output of the device according to the second aspect.

In one specific embodiment of the present invention, a function which is used to carry out the method according to the first aspect is an element selected from the following group of functions: remote control function, communication function between the robot and the factory infrastructure and/or the remote control device, evaluation function of surroundings sensor data of a surroundings sensor, planning function, in particular, driving planning function, traffic analysis function.

A computer protection level defines, in particular, the following: activated firewall and/or valid encryption certificate for encrypting a communication between the robot and the infrastructure, in particular, factory infrastructure, and/or the remote control device and/or activated virus program including current virus signatures and/or presence of a protection, in particular a mechanical protection, in particular, a break-in protection, of the computer, in particular of the device according to the second aspect, and/or the remote control device and/or presence of a checking option that signals, in particular, remote control signals and/or surroundings signals, were transferred correctly, i.e., error-free.

An algorithm encompasses, for example, a computer program according to the third aspect.

Checking that a redundancy and/or diversity exists in predetermined components and/or algorithms and/or communication options, in particular, yields the technical advantage that, in the event of a failure of the corresponding component, for example of a processor, and/or of the corresponding algorithm and/or of the corresponding communication option, a safe function may nonetheless be carried out.

To ensure that results are correct, according to one specific embodiment of the present invention, for example, they may be calculated multiple times, and corresponding results may be compared to one another. Only when the results agree is it determined, for example, that the results are correct. If ‘multiple times’ is an odd number, it may be provided, for example, that it is determined that the result corresponding to the highest number of identical results is correct.

Remote control signals are only generated, for example, when it is possible to determine that the result is correct.

In one specific embodiment of the present invention, it is provided that the remote control signals are only generated when the at least one safety condition is met.

In one specific embodiment of the present invention, it is provided that the check whether the at least one safety condition is met is carried out prior to and/or after and/or during one or multiple predetermined method step(s).

In particular, this yields the technical advantage that it may be efficiently ensured that certain prerequisites, in the present example the safety condition, are met for remotely controlling the robot before and/or after and/or while the corresponding method steps are carried out. This, in particular, thus yields the technical advantage that, when the safety condition is met, it is safely possible to remotely control the robot.

According to one specific embodiment of the present invention, it is provided that, after the remote control signals are output, a remote control of the robot based on the output remote control signals is checked to detect an error, communication message signals being generated and output upon detection of an error, which represent a communication message to be transmitted to a terminal, which encompasses a warning and/or an indication and/or a recommendation for action.

This, in particular, yields the technical advantage that a user of the terminal may be efficiently informed that an error has occurred, or what the user of the terminal should do in this case.

A terminal is a mobile terminal, for example, in particular a cell phone.

According to one specific embodiment of the present invention, it is provided that the output of the communication message signals encompasses a transmission of the communication message signals via a communication network, in particular, via a wireless communication network, to the terminal.

According to one specific embodiment of the present invention, it is provided that, after the remote control signals are output, a remote control of the robot based on the output remote control signals is checked to detect an error, communication system control signals for controlling a communication system situated within the factory infrastructure being generated and output, upon detection of an error, in such a way that, when the communication system is controlled based on the generated communication system control signals, the communication system outputs a warning and/or an indication and/or a recommendation for action.

This, for example, yields the technical advantage that persons situated within the factory infrastructure may be efficiently informed about the occurrence of an error, or that the persons may be efficiently informed about what they should do in such a case.

According to one specific embodiment of the present invention, a communication system includes one or multiple signaling device(s). A signaling device is, for example, a visual signaling device, an acoustic signaling device or a haptic signaling device. The signaling devices are, for example, at least partially different or dissimilar.

According to one specific embodiment of the present invention, the communication system includes one or multiple screen(s) or display device(s).

An acoustic signaling device is a loudspeaker, for example.

According to one specific embodiment of the present invention, the individual elements of the communication system, i.e., in particular, the signaling devices and/or the screens or display devices, are situated spatially distributed within the factory infrastructure.

In one specific embodiment of the present invention, it is provided that, after the remote control signals are output, a remote control of the robot based on the output remote control signals is checked to detect an error, the remote control being aborted upon detection of an error, or emergency remote control signals being generated and output for remotely controlling the robot in an emergency.

The emergency remote control signals are, for example, in such a way that the robot is transferred into a safe state, in particular, is stopped, during a remote control of the lateral and/or longitudinal guidance of the robot based on the emergency remote control signals.

In one specific embodiment of the present invention, it is provided that the check of the remote control encompasses checking whether the at least one safety condition is met, it being established that a result which indicates that the at least one safety condition is not met is an error.

This yields the technical advantage, for example, that it is possible to efficiently respond to the fact that the at least one safety condition is no longer met during the remote control of the robot based on the generated remote control signals.

According to one specific embodiment of the present invention, it is provided that the check of the remote control encompasses checking whether the at least one safety condition is met, it being established that a result which indicates that the at least one safety condition is not met is an error.

This yields the technical advantage, for example, that it is possible to efficiently respond to the fact that the at least one safety condition is no longer met during the remote control of the robot based on the generated remote control signals.

According to one specific embodiment of the present invention, it is provided that the surroundings signals are processed to ascertain an instantaneous state of the surroundings and/or to predict a future state of the surroundings, the remote control signals being generated based on the instantaneous state and/or future state.

This, for example, yields the technical advantage that the remote control signals may be efficiently generated. In particular, this yields the technical advantage that surroundings of the robot may be efficiently taken into consideration during the generation of the remote control signals.

According to one specific embodiment of the present invention, it is provided that the state encompasses one or multiple piece(s) of the following information: position and/or velocity and/or acceleration of at least one object, position and/or velocity and/or acceleration of at least one road user, signal pattern of a traffic light system.

This yields the technical advantage, for example, that particularly suitable pieces of information are used for generating the remote control signals.

According to one specific embodiment of the present invention, it is provided that robot task signals are received, which signal a predefined task which the robot is to carry out, it being ascertained whether, and if so, how, the predefined task may be carried out by the robot, the remote control signals being generated based on a result of the ascertainment.

This, for example, yields the technical advantage that the remote control signals may be efficiently generated.

According to one specific embodiment of the present invention, it is provided that it is checked, based on the surroundings of the robot, whether a present traffic situation allows a remote control of the robot. In particular, it is provided that the remote control signals are generated and/or output based on a result of the check whether the present traffic situation allows a remote control.

For example, a remote control of the robot is dispensed with when the present traffic situation does not allow a remote control.

This, for example, yields the technical advantage that other road users in the surroundings of the robot are not jeopardized and/or injured.

According to one specific embodiment of the present invention, it is provided that one or multiple method step(s), except for the steps of generating and outputting the remote control signals, is/are carried out robot-internally and/or that one or multiple method steps(s) is/are carried out robot-externally, in particular in an infrastructure, preferably in a cloud infrastructure.

This, for example, yields the technical advantage that the corresponding method steps may be efficiently carried out redundantly. This may, in particular, advantageously further enhance a safety.

According to one specific embodiment of the present invention, it is provided that one or multiple method step(s) is/are documented, in particular, documented in a blockchain.

This, for example, yields the technical advantage that the method may even be subsequently analyzed, due to the documentation, after the method has been carried out or executed. The documenting in a blockchain, in particular, has the technical advantage that the documentation is tamper-proof and forgery-proof.

A blockchain is, in particular, a continuously expandable list of data sets, referred to as “blocks,” which are concatenated to one another with the aid of one or multiple cryptographic method(s). Each block, in particular, includes a cryptographically secure hash (variance coefficient) of the preceding block, in particular, a time stamp and, in particular, transaction data.

According to one specific embodiment of the present invention, the output of the generated remote control signals encompasses a transmission of the remote control signals via a communication network, in particular, via a wireless communication network, to the robot.

According to one specific embodiment of the present invention, the method according to the first aspect includes remotely controlling the robot based on the generated remote control signals.

In one specific embodiment of the present invention, it is provided that it is checked whether a collectivity of the robot and of factory infrastructure involved in the method disclosed herein, including a communication between the infrastructure and the robot, is safe so that the robot and/or a local and/or a global infrastructure and/or a communication between the robot and the infrastructure is/are checked accordingly. The remote control signals are, in particular, generated based on a result of the check.

This means, in particular, that the components, which are used when the method according to the first aspect is carried out, are checked for safety, i.e., whether they meet certain safety conditions, before the intervention in the driving operation is carried out, i.e., the robot is remotely controlled.

Important and/or dependent criteria are, for example, one or multiple of the above-described safety conditions.

In one specific embodiment of the present invention, it is provided that the remote control signals encompass adaptation signals for adapting at least one robot setting of a robot device of the robot.

This, for example, yields the technical advantage that the at least one robot setting may be efficiently adapted remotely.

The at least one robot device is, for example, in each case an element selected from the following group of robot devices: drive system, drive motor, in particular, electric motor, gripper, arm, step motor, steering system, braking system, illumination units, surroundings sensor.

The at least one robot setting is, for example, in each case an element selected from the following group of robot settings: drive parameter of the drive system, in particular, velocity, maximum gripping force of the gripper, maximum movement radius (influencing area or influencing range, i.e., maximum range) of an arm, maximum adjustment range of the step motor, setpoint direction or trajectory which is to be achieved with the aid of the steering system, maximum or minimum deceleration of the braking system, illumination parameters of the illumination unit, in particular, the information as to which of the illumination means (i.e., devices) of the illumination unit is to be activated or is to be deactivated, orientation of the surroundings sensor.

This means that the remote control signals do not necessarily have to control a movement of the robot, but may adapt one or multiple robot parameter(s) and/or robot setting(s).

The term “infrastructure,” as it is used above and/or below, encompasses, for example, the factory infrastructure and/or a cloud infrastructure.

According to one specific embodiment of the present invention, the factory infrastructure encompasses one or multiple building(s) and/or one or multiple hall(s).

The factory infrastructure encompasses a manufacturing line, for example.

The factory infrastructure encompasses a warehouse, for example.

The factory infrastructure encompasses, for example, one or multiple surroundings sensor(s) situated spatially distributed within the factory infrastructure.

The respective surroundings sensors of the factory infrastructure detect their respective surroundings, for example, and provide surroundings sensor data corresponding to the particular detection.

The surroundings signals encompass, for example, the surroundings sensor data and/or are based thereon.

The fact that the robot is situated within the factory infrastructure may mean, for example, that the robot is situated within a building or a hall, or outside.

According to one specific embodiment of the present invention, it is provided that the method according to the first aspect is a computer-implemented method.

According to one specific embodiment of the present invention, it is provided that the method according to the first aspect is carried out or executed with the aid of the device according to the second aspect.

Device features are derived analogously from corresponding method features, and vice versa. This means, in particular, that technical functions of the device according to the second aspect are derived analogously from corresponding technical functionalities of the method according to the first aspect, and vice versa.

The wording “at least one” stands for, in particular, “one or multiple.”

The German abbreviation “bzw.” stands for “or,” which stands for, in particular, “respectively.”

The wording “respectively” stands for, in particular, “and/or.”

Exemplary embodiments of the present invention are shown in the figures and are described in greater detail in the following description.

### BRIEF DESCRIPTION OF THE DRAWINGS

FIG. 1 shows a flowchart of a method for remotely controlling a robot, in accordance with an example embodiment of the present invention.

FIG. 2 shows a device, in accordance with an example embodiment of the present invention.

FIG. 3 shows a machine-readable memory medium, in accordance with an example embodiment of the present invention.

FIG. 4 shows a robot within a factory infrastructure, in accordance with an example embodiment of the present invention.

### DETAILED DESCRIPTION OF EXAMPLE EMBODIMENTS

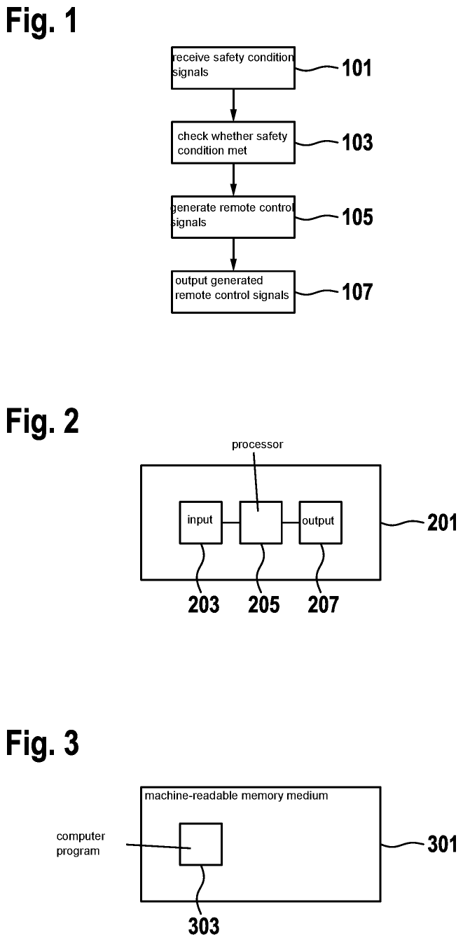

FIG. 1 shows a flowchart of a method for remotely controlling a robot.

The method includes the following steps:

receiving 101 safety condition signals, which represent at least one safety condition which must be met for the robot to be allowed to be remotely controlled;

checking 103 whether the at least one safety condition is met;

generating 105 remote control signals for remotely controlling the robot based on a result of the check whether the at least one safety condition is met; and

outputting 107 the generated remote control signals.

In one further specific embodiment, which is not shown, the method according to the first aspect includes a step of determining that a robot is to be remotely controlled.

In one specific embodiment, it is provided that request signals are received, which represent a request for a remote control of a robot.

In response to the reception of the request signals, it is determined, according to one specific embodiment, that a robot is to be remotely controlled.

In one specific embodiment, it is provided that situation signals are received, which represent a situation in which a robot is situated. According to one specific embodiment, the situation signals are processed to ascertain whether the robot must be remotely controlled. If it is ascertained that the robot must be remotely controlled, it is determined, according to one specific embodiment, that the robot is to be remotely controlled.

For example, the robot may be in a situation which the robot is not able to resolve or cope with independently. It is then determined, for example, that the robot is to be remotely controlled.

The result of the check indicates, for example, that the at least one safety condition is met. The result of the check indicates, for example, that the at least one safety condition is not met.

In one specific embodiment, it is provided that the remote control signals are only generated when the result of the check indicates that the at least one safety condition is met.

In one specific embodiment, it is provided that a generation of remote control signals is dispensed with when the result of the check indicates that the at least one safety condition is not met.

According to one specific embodiment, it is provided that the output 107 encompasses that the generated remote control signals are transmitted via a communication network, in particular, via a wireless communication network, to the robot.

According to one specific embodiment, the method according to the first aspect includes a step of remotely controlling the robot based on the output remote control signals.

In one specific embodiment, driving route signals are received, which represent a setpoint driving route of the robot. The remote control signals are generated, for example, based on the setpoint driving route. The check whether the at least one safety condition is met is carried out, for example, based on the setpoint driving route. It is checked, for example, based on the surroundings signals whether the robot is able to negotiate the setpoint driving route. The remote control signals are, for example, based on a result of the check based on the surroundings signals whether the robot is able to negotiate the setpoint driving route. If not, in particular, no remote control signals are generated. If so, for example, remote control signals are generated.

FIG. 2 shows a device 201.

Device 201 is configured to carry out all steps of the method according to the first aspect.

Device 201 includes an input 203, which is configured to receive the safety condition signals.

Device 201 furthermore includes a processor 205, which is configured to check whether the at least one safety condition is met.

In one further specific embodiment (not shown), processor 205 is, in particular, configured to determine that a robot is to be remotely controlled.

Processor 205 is furthermore configured to generate the remote control signals.

Device 201 furthermore includes an output 207, which is configured to output the generated remote control signals.

According to one specific embodiment, device 201 includes a remote control device, which is configured to remotely control the robot based on the output remote control signals.

In general, signals which are received are received with the aid of input 203. Input 203 is thus, in particular, configured to receive the corresponding signals.

In general, signals which are output are output with the aid of output 207. Output 207 is thus, in particular, configured to output the corresponding signals.

According to one specific embodiment, multiple processors are provided instead of the one processor 205.

According to one specific embodiment, it is provided that processor 205 is configured to carry out the steps of generating and checking described above and/or below.

In one specific embodiment, it is provided that one or multiple method step(s), except for the steps of generating and outputting the remote control signals, is/are carried out robot-internally and/or that one or multiple method steps(s) is/are carried out robot-externally, in particular in an infrastructure, preferably in a cloud infrastructure.

For example, device 201 is part of an infrastructure, in particular, a cloud infrastructure, or of the robot.

For redundantly carrying out the corresponding method steps, it may be provided, according to one specific embodiment, that multiple devices 201 are provided so that, for example, both the robot and the infrastructure, in particular, the cloud infrastructure, includes a device 201.

FIG. 3 shows a machine-readable memory medium 301.

A computer program 303 is stored on machine-readable memory medium 301, which encompasses commands which, during the execution of computer program 303 by a computer, prompt the computer to carry out a method according to the first aspect.

According to one specific embodiment, an infrastructure or an infrastructure system is provided, which, for example, includes the device according to the second aspect.

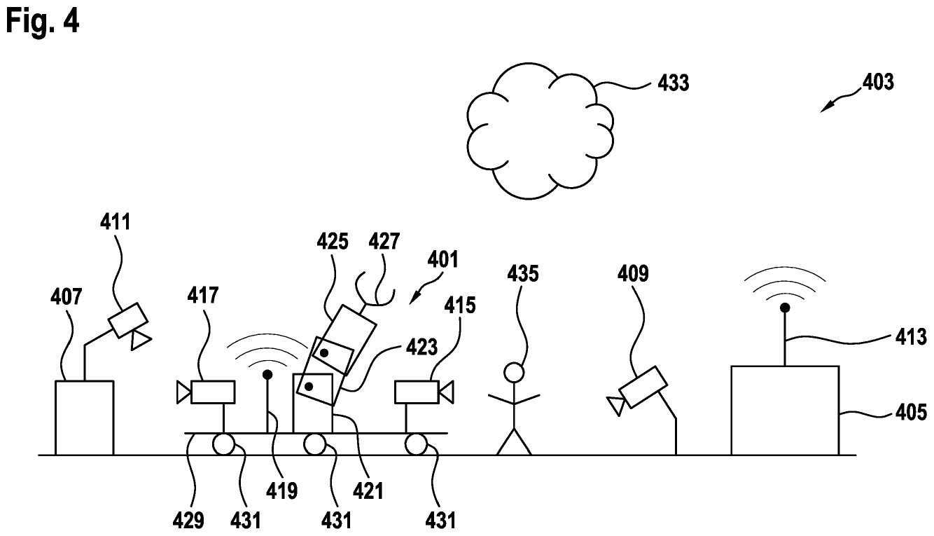

FIG. 4 shows a robot 401, which is situated within a factory infrastructure 403.

Factory infrastructure 403 includes a first building 405 and it includes a second building 407.

Within factory infrastructure 403, a first video camera 409 including a video sensor (not shown) and a second video camera 411 including a video sensor (not shown) are situated in a spatially distributed manner.

Factory infrastructure 403 furthermore includes a first wireless communication interface 413.

Robot 401 includes a third video camera 415 including a video sensor (not shown) and a fourth video camera 417 including a video sensor (not shown).

Robot 401 furthermore includes a second wireless communication interface 419.

Robot 401 includes a first arm 421 and a second arm 423 and a third arm 425, which are connected to one another in an articulated manner.

A gripper 427 is situated at third arm 425 as an example of an end effector.

Robot 401 includes a platform 429, on which the three arms 421, 423, 425 as well as third and fourth video cameras 415, 417 and second wireless communication interface 419 are situated.

Multiple casters or tires 431 are situated beneath platform 429, which may also be referred to as a support plate, so that robot 401 is a mobile robot and is able to drive within factory infrastructure 403.

Furthermore, a cloud infrastructure 433 is provided.

Both factory infrastructure 403 and robot 401 may communicate with cloud infrastructure 433 via their respective wireless communication interface.

According to one specific embodiment, for example, one or multiple step(s) of the method according to the first aspect is/are outsourced into cloud infrastructure 433.

A person 435, who is situated in the environment or in the surroundings of robot 401, is situated within factory infrastructure 403, for example.

The concept described here, among other things, provides, in particular, that robot 401 is remotely controlled through a support of an infrastructure encompassing cloud infrastructure 433 and factory infrastructure 403.

According to one specific embodiment, it is a prerequisite for the remote control and/or for the intervention that the remote control is safe. Within the meaning of the description, in particular, safe and secure are used. These two terms are typically rendered as “sicker” in German. Nonetheless, they have partially different meanings in English.

The term “safe” is, in particular, directed at the topic of accident and accident prevention. A remote control which is “safe,” in particular, causes a likelihood of an accident or a collision to be smaller than or smaller than/equal to a predetermined probability threshold value.

The term “secure” is, in particular, directed at the topic of computer protection or hacker protection, i.e., in particular, how securely a (computer) infrastructure and/or a communication infrastructure, in particular, a communication line between the robot and a remote control device for remotely controlling a robot, is secured against unauthorized accesses or against data manipulations by third parties (“hackers”).

A remote control which is “secure” thus, in particular, has adequate and sufficient computer protection or hacker protection as a basis.

According to one specific embodiment, it is checked, for example, whether the collectivity of the robot and the infrastructure involved in the method according to the first aspect, including a communication between the infrastructure and the robot, is presently secure for the concept of “infrastructure support” or “support of infrastructure” described here. This means, in particular, that the robot and/or a local and/or a global infrastructure and/or a communication is/are checked accordingly. The remote control signals are, in particular, generated based on a result of the check.

This means, in particular, that the components which are used when the method according to the first aspect is carried out, are checked for safety, i.e., whether they meet certain safety conditions, before the intervention in an operation, in particular, a driving operation is carried out, i.e., the robot is remotely controlled.

Important and/or dependent criteria are, for example, one or multiple of the above-described safety conditions.

According to one specific embodiment, it is provided that, on the one hand, the overall system (robot, infrastructure, communication line, cloud . . . ) is checked with respect to the safety condition.

According to one specific embodiment, it is provided that the individual parts are also checked with respect to the safety condition being met. This takes place, in particular, prior to a remote control of the robot.

In one specific embodiment, the step or steps of checking is/are carried out robot-internally and/or robot-externally, in particular, in an infrastructure.

According to one specific embodiment, it is provided that the step or steps of checking is/are checked subsequently, i.e., at a later point in time, for example on a regular basis. For example, the step or steps of checking is/are checked subsequently at a predetermined frequency, for example every 100 ms.

For example, according to one specific embodiment, this checking, i.e., the check whether the at least one safety condition is met, is carried out prior to and/or after and/or during one or multiple predetermined method step(s).

According to one specific embodiment, the check is carried out or executed in the event of problems.

In one specific embodiment, it is provided that a communication link is established between the robot and the infrastructure, which, in particular, includes the device according to the second aspect.

According to one specific embodiment, the infrastructure encompasses a local infrastructure.

According to one specific embodiment, the infrastructure encompasses a global infrastructure, preferably a cloud infrastructure.

In one specific embodiment, it is checked whether the functionality “infrastructure support” may be provided.

In one specific embodiment, it is checked whether the infrastructure is functionally ready and/or available for the remote control.

In one specific embodiment, it is checked whether the robot is functionally ready and/or available for the remote control.

In one specific embodiment, it is checked whether the service and/or the functionality “infrastructure support” is enabled for the robot inquiring about the functionality. This applies, in particular, at the robot level, the infrastructure level, and the service level.

In one specific embodiment, an ascertainment and/or a reception (and, in particular, a transfer) of robot options (the robot parameters described above and/or below) (for example, maximum possible acceleration and/or velocity, etc.) is/are provided.

For example, robot parameters are transmitted by the robot. This means that, for example, robot parameters transmitted by the robot are received.

For example, robot parameters are transmitted from the cloud, in particular, from a cloud server. This means that robot parameters transmitted, for example, from the cloud, in particular, from a cloud server, are received.

If this is not possible (e.g., due to missing data), a defined standard configuration (preferably an emergency configuration) is used, for example.

In one specific embodiment, a check is provided whether the traffic situation allows for the robot to be remotely controlled. This check preferably runs continuously, i.e., permanently, i.e., even before a corresponding inquiry, i.e., independently of an inquiry.

The calculation and/or ascertainment is/are carried out in the robot and/or in the infrastructure, for example. When this is carried out both in the robot and in the infrastructure, a redundancy may advantageously be achieved thereby, which may enhance a safety.

If the remote control is possible, the robot is, for example, controlled remotely. The take-over of the robot guidance thus takes place by the infrastructure. Intelligence, decision-making and control lie with the infrastructure.

The process of remote control preferably continues to be checked.

The check is carried out according to one or multiple of the following option(s):

in the robot, in the infrastructure, or both in the robot and in the infrastructure, it being possible for the latter to advantageously achieve a redundancy, which may enhance a safety.

In one further specific embodiment, the surroundings of the robot are analyzed by the infrastructure (in particular, in addition to the robot) before the robot starts to drive, and the remote control or start of the robot is only started after a start command of the infrastructure has been transmitted.

In one further specific embodiment, the infrastructure issues indications/instructions to further road users in the event of problems/possible hazardous situations, especially to pedestrians. The indications may, e.g., be output by audio, displays, etc. Furthermore, indications to (linked/known), in particular, mobile, terminals are possible.

1-19. (canceled)

20. A method for remotely controlling a robot situated within a factory infrastructure, comprising the following steps:
receiving safety condition signals, which represent at least one safety condition which must be met for the robot to be allowed to be remotely controlled;
checking whether the at least one safety condition is met;
generating remote control signals for remotely controlling the robot based on a result of the check of whether the at least one safety condition is met; and
outputting the generated remote control signals.

21. The method as recited in claim 20, wherein the at least one safety condition in each case selects one element from the following groups of safety conditions:
presence of a predetermined Safety Integrity Level of at least the robot and an infrastructure, including a communication line and/or communication components, for remotely controlling a robot with respect to the overall systems in the robot and the infrastructure;
presence of a maximum latency period of a communication between the robot and a remote control device for remotely controlling the robot based on the remote control signals;
presence of a predetermined computer protection level of a device for carrying out the method steps;
presence of predetermined components and/or algorithms and/or communication options which are used to carry out the method steps;
presence of a redundancy and/or diversity in predetermined components and/or algorithms and/or communication options which are used to carry out the method steps;
presence of predetermined availability information which indicates an availability of predetermined components and/or algorithms and/or communication options; presence of predetermined quality criteria of the predetermined components and/or algorithms and/or communication options;
presence of a plan which encompasses measures for reducing errors and/or measures in the event of failures of predetermined components and/or algorithms and/or communication options and/or measures for error analyses and/or measures in the event of misinterpretations;
presence of one or multiple fallback scenarios;
presence of a predetermined function;
presence of a predetermined traffic situation;
presence of predetermined weather;
a maximum possible time for carrying out and/or executing one or multiple of the method steps;
presence of a test result that elements and/or functions which are used to carry out the method are presently functioning error-free.

22. The method as recited in claim 21, wherein the remote control signals are generated only when the at least one safety condition is met.

23. The method as recited in claim 20, wherein the check of whether the at least one safety condition is met is carried out before and/or after and/or during one or multiple predetermined method step(s).

24. The method as recited in claim 20, wherein, after the remote control signals are output, a remote control of the robot based on the output remote control signals is checked to detect an error, communication message signals being generated and output upon detection of an error, which represent a communication message to be transmitted to a terminal, the communication message including a warning and/or an indication and/or a recommendation for action.

25. The method as recited in claim 20, wherein, after the remote control signals are output, a remote control of the robot based on the output remote control signals is checked to detect an error, communication system control signals for controlling a communication system situated within the factory infrastructure being generated and output upon detection of an error, in such a way that, when the communication system is controlled based on the generated communication system control signals, the communication system outputs a warning and/or an indication and/or a recommendation for action.

26. The method as recited in claim 20, wherein, after the remote control signals are output, a remote control of the robot based on the output remote control signals is checked to detect an error, the remote control being aborted upon detection of an error, or emergency remote control signals being generated and output for remotely controlling the robot in an emergency.

27. The method as recited in claim 25, wherein the check of the remote control encompasses checking whether the at least one safety condition is met, it being established that a result which indicates that the at least one safety condition is not met is an error.

28. The method as recited in claim 20, wherein surroundings signals are received, which represent surroundings of the robot, the remote control signals being generated based on the surroundings.

29. The method as recited in claim 28, wherein the surroundings signals are processed to ascertain an instantaneous state of the surroundings and/or to predict a future state of the surroundings, the remote control signals being generated based on the instantaneous state and/or the future state.

30. The method as recited in claim 29, wherein the instantaneous and/or future state encompasses one or multiple pieces of the following information: position and/or velocity and/or acceleration of at least one object, position and/or velocity and/or acceleration of at least one road user, signal pattern of a traffic light system.

31. The method as recited in claim 20, wherein robot task signals are received, which signal a predefined task which the robot is to carry out, it being ascertained whether and how the predefined task may be carried out by the robot, the remote control signals being generated based on a result of the ascertainment.

32. The method as recited in claim 20, wherein one or multiple of the method steps, except for the steps of generating and outputting the remote control signals is carried out robot-internally and/or one or multiple of the method steps is carried out robot-externally, in an infrastructure.

33. The method as recited in claim 32, wherein the infrastructure is a cloud infrastructure.

34. The method as recited in claim 20, wherein one or multiple of the method steps is documented in a blockchain.

35. The method as recited in claim 20, wherein it is checked whether the robot and an infrastructure involved in the method are safe, including a communication between the infrastructure and the robot.

36. The method as recited in claim 35, wherein the robot and/or the infrastructure and/or a communication between the robot and the infrastructure are checked as to whether they are safe.

37. The method as recited in claim 20, wherein the robot is a mobile robot.

38. A device configured to remotely control a robot situated within a factory infrastructure, the device configured to:
receive safety condition signals, which represent at least one safety condition which must be met for the robot to be allowed to be remotely controlled;
check whether the at least one safety condition is met;
generate remote control signals for remotely controlling the robot based on a result of the check of whether the at least one safety condition is met; and
output the generated remote control signals.

39. A non-transitory machine-readable memory medium on which is stored a computer program for remotely controlling a robot situated within a factory infrastructure, the computer program, when executed by a computer, causing the computer to perform the following steps:
receiving safety condition signals, which represent at least one safety condition which must be met for the robot to be allowed to be remotely controlled;
checking whether the at least one safety condition is met;
generating remote control signals for remotely controlling the robot based on a result of the check of whether the at least one safety condition is met; and
outputting the generated remote control signals.
